(19) United States
(12) Patent Application Publication
(10) Pub. No.: US 2025/0046489 A1
(43) Pub. Date: Feb. 6, 2025

(54) DISTRIBUTED PROCESSOR MODULE TO ENABLE SMART SENSORS

(71) Applicant: Triad National Security, LLC, Los Alamos, NM (US)

(72) Inventors: Keith S. Morgan, Los Alamos, NM (US); Paul Stanley Graham, Los Alamos, NM (US); Jonathan Ray Deming, Los Alamos, NM (US); Daniel Wayne Arnold, Los Alamos, NM (US); Justin Leonard Tripp, Los Alamos, NM (US)

(21) Appl. No.: 18/793,416

(22) Filed: Aug. 2, 2024

Related U.S. Application Data
(60) Provisional application No. 63/517,590, filed on Aug. 3, 2023.

(51) Int. Cl. G21K 1/10; G01T 1/36

(52) U.S. Cl. CPC G21K 1/10; G01T 1/36

(57) ABSTRACT

A distributed computing system for a space flight environment includes a radiation hardened single board computer and a peripheral board including a radiation hardened processor module. The radiation hardened single board computer includes a first radiation hardened processor and a first radiation hardened field programmable gate array. The radiation hardened processor module includes a second radiation hardened processor and a second radiation hardened field programmable gate array. The radiation hardened processor module is connected to the radiation hardened single board computer through a VPX backplane.

### ACKNOWLEDGEMENT OF GOVERNMENT SUPPORT

This invention was made with government support under Contract No. 89233218CNA000001 awarded by the U.S. Department of Energy/National Nuclear Security Administration. The government has certain rights in the invention.

### FIELD

The present disclosure concerns systems and methods related to hardened processor modules for distributed computing in a space flight environment.

### BACKGROUND

In space flight environments, characterized by extreme temperatures, microgravity, and high levels of radiation, computing systems traditionally employ a centralized hub, known as a “backplane in a box,” for command, data handling, processing, and power distribution. This centralized approach makes it challenging for system integration. For example, the addition or subtraction of individual sub-instruments, such as space environment sensors, can be complicated. Thus, room for improvement exists for developing more robust, adaptable, and efficient computing systems that can withstand the harsh space environment.

### SUMMARY

Described herein are apparatuses, systems, and methods related to hardened processor modules for distributed computing in a space flight environment.

In some aspects, the techniques described herein relate to a distributed computing system for a space flight environment. The distributed computing system includes a radiation hardened single board computer (SBC), and a peripheral board including a radiation hardened processor module. The radiation hardened SBC includes a first radiation hardened processor and a first radiation hardened field programmable gate array (FPGA). The radiation hardened processor module includes a second radiation hardened processor and a second radiation hardened FPGA. The radiation hardened processor module is connected to the radiation hardened SBC through a VPX backplane.

In some aspects, the techniques described herein relate to a distributed computing system for a space-flight environment. The distributed computing system includes a first sensor board including a first sensor and a radiation hardened processor module, and a second sensor board including a second sensor different from the first sensor and the radiation hardened processor module. The radiation hardened processor module includes a radiation hardened processor and a radiation hardened field programmable gate array. The radiation hardened processor modules of both the first sensor board and the second sensor board are connected to a radiation hardened payload processor through a VPX backplane.

In some aspects, the techniques described herein relate to a method for distributed data processing in a space flight environment. The method includes measuring a parameter of the space flight environment using a sensor located on a sensor board which includes a radiation hardened processor module, generating processed data by processing the parameter using a field programmable gate array and a processor of the radiation hardened processor module, and sending the processed data to a radiation hardened payload processor through a VPX backplane. Both the sensor board and the radiation hardened payload processor are connected to the VPX backplane.

The foregoing and other features and advantages of the disclosed technologies will become more apparent from the following detailed description, which proceeds with reference to the accompanying figures.

### BRIEF DESCRIPTION OF THE DRAWINGS

Illustrative, non-limiting examples will be more clearly understood from the following detailed description taken in conjunction with the accompanying drawings.

FIG. 1 is an overall block diagram of an example distributed computing system for a space flight environment.

FIG. 2 is an example architectural block diagram of a single board computer.

FIG. 3 is a block diagram of an example distributed processor module.

FIG. 4 is a schematic diagram of a wide field-of-view plasma spectrometer.

FIG. 5 is a cutaway view of a computer-aided design model of an energetic charged particle telescope.

FIG. 6 is a flowchart depicting an example method for distributed data processing in a space flight environment.

### DETAILED DESCRIPTION

### Overview of Computing Systems for Space Flight Environments

Computing systems for space flight applications, operating in diverse environments such as geosynchronous Earth orbit (GEO), medium earth orbit (MEO), and low earth orbit (LEO), face many unique challenges. These include the need to withstand harsh conditions such as radiation, extreme temperatures, and the vacuum of space, while providing reliable, high-performance computing capabilities.

A significant development in the field has been the adoption of the VPX family of standards, which aim to establish a standardized framework for interconnections between various components within space systems. The base VPX specification, ANSI/VITA 46, outlines the mechanical module form factors, connectors, power rails, and basic interfaces. Additional guidance on the implementation of specific high-speed serial fabrics, such as Gigabit Ethernet, is provided by the “DOT” specifications, like ANSI/VITA 46.6. However, the flexibility offered by VPX led to interoperability issues among modules that met the specification. To address this, the industry developed OpenVPX (ANSI/VITA 65), an extension to VPX that provides a more detailed definition of high-speed serial interfaces, specifies module profiles and backplane topologies, and includes rules and tables for compatibility.

SpaceVPX, another extension to OpenVPX, is specifically designed for space applications. Nominally, SpaceVPX is a version of OpenVPX that allows the use of SpaceWire, supports redundancy, and incorporates a power control scheme more suitable for space environments. The objective is to enable engineers to develop space-grade hardware in the cost-effective OpenVPX environment and then transition to the more expensive SpaceVPX environment once most of the work is completed. However, it is important to note that SpaceVPX is not entirely compatible with OpenVPX. While they are mechanically compatible, share the same power connections, and have signal levels that will not damage each other, they are not protocol-compatible and will not interoperate on the control plane. For instance, OpenVPX specifies Ethernet on the control plane, while SpaceVPX specifies SpaceWire. Efforts have been made previously to facilitate interoperability between OpenVPX and SpaceVPX, enabling the utilization of cost-effective commercial hardware during the prototyping phase, as opposed to the more expensive hardware designed for spaceflight applications.

In terms of form factors, existing systems that integrate OpenVPX and SpaceVPX are typically limited to 6U Eurocard VPX, also referred to as “6U module.” This may not be a one-size-fits-all solution for many space flight applications. For example, some smaller satellite hosts may require systems to have a low size, weight, and power (SWaP). The 6U module, with a measured size about 230 mm×160 mm, has a much larger form factor than a 3U Eurocard VPX, also referred to as “3U module,” which has a dimension about 100 mm×160 mm. The 6U module can also consume more power than the 3U module.

Traditional computing systems for space flight applications typically depend on a centralized hub for command, data handling, processing, and power distribution. This centralized design often falls short in terms of flexibility and adaptability, especially when it comes to meeting the dynamic requirements of various space missions. A significant challenge arises when different modules, developed by different teams, use incompatible frameworks. This incompatibility can prevent these modules from communicating with each other, necessitating sophisticated interface designs for system integration. Additionally, modifications to the system configuration can be complex and time-consuming, adding to the operational challenges. Moreover, the centralized nature of these systems can lead to inefficiencies, as the addition or subtraction of components can leave unused capacity in the system.

Disclosed herein are distributed computing systems and related methods for space flight applications. These systems aim to overcome the limitations of traditional centralized hub systems and offer more flexibility and adaptability. They are designed to meet the rigorous command and data-handling requirements of missions that demand true space-grade radiation hardness and fault tolerance. These systems can have significantly reduced cost, lower power consumption, and smaller form factor compared to currently available space-grade solutions.

### Example Distributed Computing System for Space Flight Applications

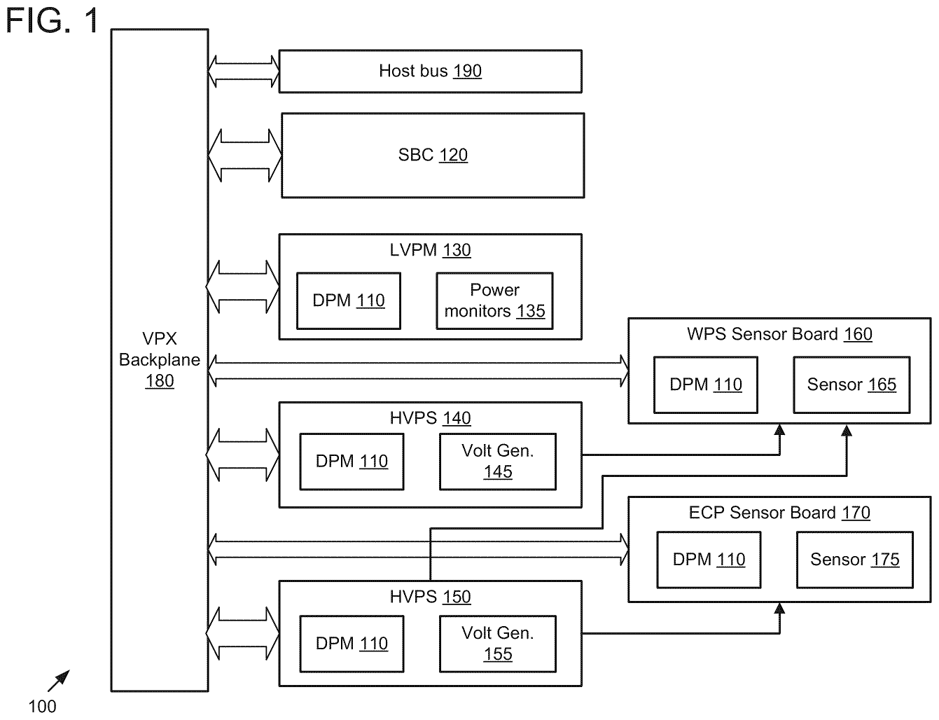

FIG. 1 shows an example distributed computing system 100 which can be used in a space flight environment.

In the depicted example, the computing system 100 includes multiple subsystems, such as a single-board computer (SBC) 120, a low voltage power monitor (LVPM) board 130, a first high voltage power supply (HVPS) board 140, a second HVPS board 150, a wide field-of-view plasma spectrometer (WPS) sensor board 160, and an energetic charged particle (ECP) telescope 170, all connected to a VPX backplane 180. The computing system 100 also includes a host bus 190 serving as the main communication pathway for data and control signals between various system components, ensuring coordinated operation within the computing system 100.

In some examples, the VPX backplane 180 can be configured to have a 3U-sized form factor. In some examples, the SBC 120, LVPM board 130, first HVPS board 140, and second HVPS board 150 can be enclosed within a VPX chassis and directly connected to the VPX backplane 180. In some examples, the WPS sensor board 160 can be connected to the VPX backplane 180 via an MDM-31 plug and the ECP telescope 170 can be connected to the VPX backplane 180 via an MDM-37 plug.

The SBC 120, which can also be referred to as a payload processor, serves as the primary computing platform on spacecraft, satellites, and space probes. The SBC 120 can function as a system controller for a set of instruments (e.g., including the WPS and ECP telescope) in earth orbit applications. For example, the SBC 120 can be used to perform various functions including attitude and orbit control, telemetry data management, telecommunication actions, system housekeeping, on-board time synchronization, failure detection, isolation, and recovery, etc. The SBC 120 is configured to be radiation hardened so as to withstand high radiation dose in the space flight environment. Additional details of the SBC 120 are described more fully below.

As shown in FIG. 1, except for the SBC 120, each board connected to the VPX backplane 180 can include an on-board distributed processor module (DPM) 110 and front-end electronics that are specific to the board. For example, the WPS sensor board 160 includes the DPM 110 and a WPS sensor 165, the ECP telescope 170 includes the DPM 110 and an ECP sensor 175, the LVPM board 130 includes the DPM 110 and one or more power monitors 135, the first HVPS board 140 includes the DPM 110 and one or more voltage generators 145, and the second HVPS board 150 also includes the DPM 110 and one or more voltage generators 155.

In other words, these boards share the same DPM 110 hardware, which can be individually programmed in firmware to work with corresponding front-end electronics (e.g., WPS sensor 165, ECP sensor 175, power monitors 135, voltage generators 145 and 155, etc.) to achieve specific functions. This shared hardware structure allows for fast design and testing, as the same DPM 110 can be used across different boards, reducing the time and resources required for hardware development. It also enhances reusability, as the same DPM 110 can be used in different contexts with different front-end electronics. Further, it improves compatibility for communication among the boards, as they all use the same DPM 110, facilitating their ability to “talk” to each other.

As described more fully below, the DPM 110 can include a processor and a coprocessor such as an FPGA. This configuration empowers the DPM 110 to execute a variety of data processing tasks. Having on-board DPM 110 allows an individual board to offload some of the computation burden from the SBC 120. For example, the DPM 110 on a sensor board can process raw data measured by a sensor on the sensor board, convert it into a condensed or more manageable format, before sending such processed data to the SBC 120 for further processing and/or storage.

In some examples, the DPM 110 on the WPS sensor board 160 is configured to control operation of the WPS sensor 165, initially process data measured by the WPS sensor 165, and send the processed data to the SBC 120 for further processing and/or storage. As described more fully below, the WPS sensor 165 can be configured to measure incident ion and electron energies and incident angles over a nearly 2π field-of-view (FOV), acquiring a complete plasma measurement in a single voltage sweep. This allows for the study of ultrafast dynamic processes of the solar wind and magnetospheric plasma environments.

As described further below, the WPS sensor 165 can include an energy-angle (EA) filter plate, a microchannel plate (MCP) detector, and a transmissive grid. These components require specific high voltage supplies for operation. In some examples, the first HVPS board 140, controlled by its on-board DPM 110, can be used to generate a stepping voltage via the voltage generator 145 to sweep the EA filter plate (e.g., from −10V to −5 kV). Similarly, the second HVPS board 150, controlled by its on-board DPM 110, can be used to generate static voltages via the voltage generator 155 to bias the MCP and the transmissive grid.

In some examples, the DPM 110 on the ECP telescope 170 is configured to control operation of the ECP sensor 175, initially process data measured by the ECP sensor 175, and send the processed data to the SBC 120 for further processing and/or storage. As described further below, the ECP telescope 170 can be configured for measuring protons and electrons over a broad range of energies in space flight applications. In some examples, the ECP sensor 175 may require a static high voltage to provide operational bias to the solid-state detectors. In some examples, the second HVPS board 150, controlled by its on-board DPM 110, can be used to generate such bias voltages via the voltage generator 155.

In some examples, the LVPM board 130 can be configured as a power monitoring and load shedding interface. Specifically, its on-board DPM 110 can control operation of multiple power monitors 135, each being configured to measure and report quality and individual power consumption of a subsystem (e.g., a specific board) in the computing system 100 and perform load shedding as needed. For example, based on power consumption and power quality data of a subsystem measured by a corresponding power monitor 135, the on-board DPM 110 can send enable/disable signals to the subsystem to switch between different power modes (e.g., a high-power mode for full operation, a low-power mode for preserving volatile memory, or the like). In the event of power overload or an instrument fault, the DPM 110 can implement load shedding, e.g., by autonomously disabling power to certain subsystems to maintain power stability across the system. Additionally, during a power upset, the LVPM board 130 can be configured to enable local switched mode power supplies that draw directly from the raw battery voltage to mitigate the risk of loss of mission data from volatile memory on the SBC 120.

The standardized DPM 110, present on individual boards, ensures compatibility between different boards in the computing system 100. As described more fully below, the DPM 110 can support various serial communication protocols (e.g., SpaceWire, Ethernet, etc.), enabling efficient communications between different boards. In some examples, the inter-board communication can be facilitated through the VPX backplane 180, which serves as a communication pathway for data and control signals between various system components. In addition to serial communication, the computing system 100 can also support direct board-to-board communication, which can be particularly useful for tasks such as supplying high voltages to sensor boards and/or measuring power consumption of individual boards, as described above.

### Example Payload Processor

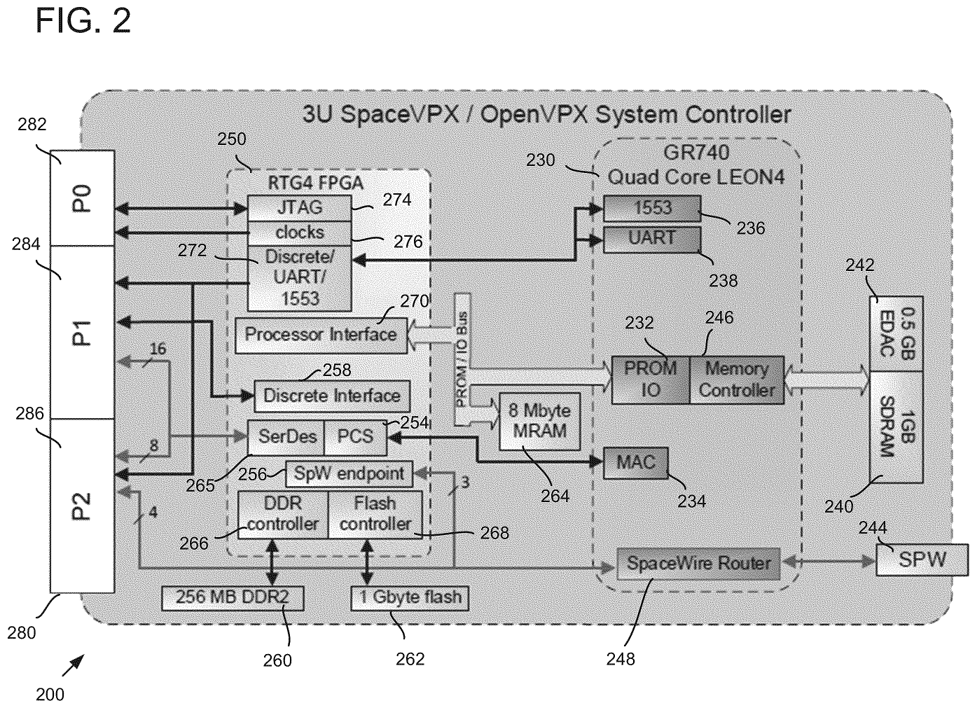

FIG. 2 depicts an example architectural block diagram of an SBC 200, which can be an example embodiment of the SBC 120 of FIG. 1. The SBC 200 can function as a command and data-handling payload processor or system controller for a set of space instruments in earth orbit applications (e.g., MEO, LEO, and GEO applications). In certain aspects, the SBC 200 is configured to operate at low power, consuming about 5 W or less.

In certain aspects, the SBC 200 is radiation hardened so that it can tolerate at least a 100 Krad total ionizing dose (TID) and immunity to latch up at 103 MeV/mg/cm². In certain aspects, the SBC 200 can be housed in a conduction-cooled frame and is mechanically hardened. For example, the conduction-cooled frame may be manufactured from 6061-T6 aluminum and may use wedge locks. The conduction cooled frame may be mechanically hardened to meet or exceed NASA General Environmental Verification Standard (GEVS) for shock, vibration, and thermal conditions encountered during launch.

The SBC 200 can have a 3U-sized form factor, with a board-level physical layer interface 280 configured to be connected to the VPX backplane 180. Thus, the SBC 200 can be interconnected with other 3U-sized boards (e.g., sensor heads or boards of various space instruments) through the VPX backplane 180. As shown, the board-level physical layer interface 280 can have three backplane connectors (e.g., P0, P1, and P2), each having a predetermined number of pins. The backplane connectors can be hypertac connectors that are either QMLV or Class S grade with TID tolerance appropriate for deployment on long-term missions in MEO, LEO, or GEO environments.

In certain aspects, the SBC 200 is interoperable between OpenVPX and SpaceVPX, and comply with ANSI/VITA 65 and 78. For example, the SBC 200 can have SLT3-SWH-6F6U-14.4.1 and SLT3-SWC-4F6T-14.5.1 system controller and switch slot profiles.

As shown in FIG. 2, the SBC 200 includes a processor 230 and a co-processor or field programmable gate array (FPGA) 250. The SBC 200 can also include one or more volatile memories directly connected to the processor 230. For example, the processor 230 can be directly connected to a synchronous dynamic random-access memory (SDRAM) 240 and an error detection and correction (EDAC) memory 242. The SBC 200 can also include volatile and non-volatile memories that are directly connected to the FPGA 250. For example, the FPGA 250 can be directly connected to a double data rate 2 (DDR2) SDRAM, or simply DDR2 memory 260, as well as a flash memory 262. Additionally, the SBC 200 can have a non-volatile read-only memory (ROM) and a magneto-resistive random-access memory (MRAM) 264 in communication with both the processor 230 and the FPGA 250.

### Processor

The processor 230 can be an application-specific integrated circuit (ASIC) configured to execute flight software and occupy the top level of control of the SBC 200. In one specific example, the processor 230 can be a GR740™ processor, which is a radiation-hardened System-on-Chip (SoC) featuring a quad-core fault-tolerant LEON4 processor. The GR740 processor can operate at a core clock of 250 MHz and deliver a performance of 258 Dhrystone MIPS per core. The processor 230 can be configured to run VxWorks™ real-time operating system.

In some examples, the processor 230 can have additional built-in hardware that implements several interface functions including, but not limited to, an SpaceWire router 248, a memory controller 246, a programmable ROM (PROM) and Input Output (IO) controller 232, at least one Ethernet media access controller (MAC) 234, an MIL-STD-1553B interface 236, and a universal asynchronous receiver/transmitter (UART) 238.

SpaceWire is a high-speed communication protocol designed for use in spacecraft and satellite systems. In some examples, serialized sensor data from one or more sensor boards can be sent to the SBC 200 via SpaceWire. The SpaceWire router 248 is configured to facilitate communication in a SpaceWire network. The SpaceWire router 248 connects together many nodes using SpaceWire links, providing a means of routing packets from one node to any of the other nodes or routers attached to the SpaceWire router 248. In one specific example, the SpaceWire router 248 has 8 ports or lanes (also referred to as “thin pipes”). One port of the SpaceWire router 248 can be a SpaceWire link 244 connected to the front panel of the SBC 200. Three ports of the SpaceWire router 248 can connect between the processor 230 and the FPGA 250. Four other ports of the SpaceWire router 248 can connect the processor 230 to the board-level physical layer interface 280. Thus, other boards in the computing system can communicate with either the processor 230 or FPGA 250 (or both) through the SpaceWire router 248 in the processor 230.

UART, which can also be referred to as a serial transceiver, is a hardware communication protocol that uses asynchronous serial communication with configurable speed, and it can use two wires for its transmitting and receiving ends. The MIL-STD-1553 is a military protocol that defines the mechanical, electrical, and functional characteristics of a serial data bus. The MIL-STD-1553B interface 236 can provide a single 1 Mb/s channel/port with redundancy.

### SRAM and EDAC Memory

The processor 230 can interact with the SDRAM 240 and the EDAC memory 242 through its memory controller 246. For example, GR740 features a 64-bit memory interface with the SDRAM 240 and the EDAC memory 242. In some examples, the EDAC memory 242 can be part of the SDRAM 240. In one specific example, the size of the SDRAM 240 can be 1 gigabyte and the size of the EDAC memory 242 can be 512 megabyte. In other examples, the EDAC memory 242 and/or the SDRAM 240 can have different sizes.

The SDRAM 240 can support various functionalities such as storing and retrieving data on demand and providing temporary storage for the processor 230. The SDRAM 240 operates synchronously with the clock speed that the processor 230 is optimized for, thus it can significantly increase the processor's performance. The SDRAM 240 can also support multiple internal banks for efficient data transfer, burst mode for fast data transfer rate, several power-down states to conserve energy when not in use, and a self-refresh mode which allows the SDRAM 240 to refresh itself while the computer is in sleep mode. The processor 230 can employ the EDAC memory 242 to implement an EDAC scheme. For example, when the memory controller 246 with EDAC enabled detects a correctable error, the data can be temporarily corrected and delivered onto the on-chip bus, thus allowing the processor 230 to execute correctly despite the correctable errors that occur, and scrubbing in software or hardware can be designed on top of that to prevent building up multiple single-bit errors over time to a double error. Additional details of error detection and correction are described in U.S. Pat. Nos. 10,503,584 and 10,521,295, both of which are incorporated herein by reference in their entireties.

### MRAM

In some examples, flight software for the processor 230 can be stored in the MRAM 264. In one specific example, the size of the MRAM 264 can be 8 MB. The boot loader for the SBC 200 can be stored in the MRAM 264, accessed during power-up or reset to load program code directly from the MRAM 264. MRAM, a non-volatile RAM utilizing magnetic charges for data storage, offers a unique blend of high-speed data access akin to RAM and high-density data storage akin to flash memory. In this configuration, without a separate ROM, the boot loader within the MRAM 264 can initiate the startup process and seamlessly transfer control to the flight software, which can also reside in the MRAM 264 upon system power-up or reset. This consolidation of the boot loader and program code within the MRAM 264 can streamline the startup procedure, enhancing efficiency and data accessibility for the SBC 200.

### FPGA

The FPGA 250 can be configured to perform co-processing functions to reduce the load on the processor 230. The FPGA 250 may be mapped into the I/O space of the processor 230. The processor 230 may read and write to registers in this I/O space to communicate with the FPGA 250.

Using this technique, the FPGA 250 may handle interface functions that would otherwise consume bandwidth of the processor 230. The FPGA 250 can also have built-in physical layer support for various physical-layer interfaces. For example, the FPGA 250 can be equipped with physical interfaces for high-speed serial, Low-Voltage Differential Signaling (LVDS), inter-IC (I2C), and Joint Test Action Group (JTAG) interfaces. These interfaces can be facilitated by hard intellectual property (IP) blocks or cores that are instantiated within the FPGA 250. These hard IP blocks can be accessed and manipulated by configurable designs, also known as soft designs, within the user fabric of the FPGA 250. The FPGA 250 can support a variety of interfaces through Very High-Speed Integrated Circuit Hardware Description Language (VHDL) IP cores. These include, but are not limited to, flash memory interfaces, I2C Interfaces, SpaceWire, and JTAG.

In one specific example, the FPGA 250 can be a Microchip RTG4™ FPGA, supplying programmable hardware resources for user-defined hardware acceleration of the processor 230. The RTG4™ is a radiation-tolerant FPGA that can be reconfigured in-circuit, e.g., via a JTAG connection. Mathematically intense algorithms, such as digital filters or Fast Fourier Transform (FFT), can be implemented in this reconfigurable hardware. The RTG4™ has about 151,000 logic elements, 720 user IOs, 5.3 Mbits of SRAM, and 24 multi-gigabit serializer/deserializer (SerDes). The RTG4™ has radiation-hardened hardware support for high-speed SerDes, which are needed for Ethernet, Serial RapidIO, and other Current Mode Logic (CML)-based protocols. These high-speed SerDes can be used to support the “common-options” lanes or channels defined in the standard for primary communication with other OpenVPX/SpaceVPX cards in a VPX system. These high-speed lanes can support Ethernet, PCI Express, and Serial RapidIO. The RTG4™ may directly support Peripheral Component Interconnect (PCI) Express endpoints in hardware and support Ethernet and Serial RapidIO at the physical layer. For a PCI Express root complex, Ethernet, and Serial RapidIO, full stacks may be instantiated as IP cores in the fabric.

As shown in FIG. 2, the FPGA 250 can include, but is not limited to: a JTAG interface 274, one or more clocks 276, a serial gate 272, a processor interface 270, a discrete interface 258, a 24-channel SerDes 265, a physical coding sublayer (PCS) unit 254, at least one SpaceWire (SpW) endpoint 256, a DDR controller 266, and a flash controller 268.

Both the JTAG interface 274 and the clocks 276 can be connected to the P0 connector 282. The JTAG interface 274 can be used for testing, programming, and debugging of the FPGA 250. The one or more clocks 276 may be generated by the FPGA 250 or received via a utility bus through the P0 connector 282.

The processor interface 270 serves as a communication bridge between the FPGA 250 and processor 230. For example, the processor interface 270 can be connected to the PROM IO controller 232 of the processor 230 via a PROM IO bus. The processor interface 270 can facilitate data transfer, control the flow of information, and manage read/write operations. It also enables the FPGA 250 to interact with the MRAM 264, allowing it to access stored program code for execution.

The serial gate 272 within the FPGA 250 is configured to route serial signals from the processor 230 to the backplane, depending on application needs. For example, if MIL-STD-1553B is needed, the MIL-STD-1553B control signals generated by the MIL-STD-1553B interface 236 of the processor 230 can be passed through the FPGA 250 (e.g., via the serial gate 272) to one or more connectors (e.g., the P1 connector 284 and the P2 connector 286) of the board-level physical layer interface 280. If MIL-STD-1553B is not needed, the serial gate 272 can be configured to pass other signals (e.g., the UART signals generated by the UART 238, or other discrete serial signals) of the processor 230 to the same pins on those connectors. In other words, some pins in those connectors can be shared by MIL-STD-1553B, UART, and other serial signals, and the FPGA 250 can be configured to determine how the pins are shared depending on the applications that are desired. Through the serial gate 272, the FPGA 250 also enables the processor 230 to access the SerDes 265. Thus, through the serial gate 272 of the FPGA 250, the processor 230 can perform UART and/or MIL-STD-1553 communications with boards or devices external to the SBC 200.

The discrete interface 258 allows the FPGA 250 to communicate with external hardware devices through specific, individual connections. For example, the discrete interface 258 can be dedicated communication channels that allow the FPGA 250 to send and receive data from a connected external connector, such as the P1 connector 284.

The SerDes 265 of the FPGA 250 operates by converting parallel data into serial data for transmission (serialization) and converting received serial data back into parallel data (deserialization). In some examples, the FPGA 250 can have 24 multi-gigabit lanes to support high-speed serial protocols (e.g., data rates between 1 Gbps and 3.125 Gbps). The 24 SerDes lanes can be used as 24 individual communications channels/ports or they can be aggregated into a few multi-lane communications channels/ports (e.g., 4, 8, or 16 SerDes lanes per communication channel) to distribute fewer independent data streams, but at a much higher rate per data stream. The high-speed SerDes 265 can be configured to support several serial communication standards, such as PCI Express, Serial RapidIO, Ethernet, and other CML-based protocols. Specifically, the FPGA 250 can provide JESD204B support for direct connection to digitizer/instrument cards through the high-speed SerDes 265. For example, the SerDes 265 can interface with an analog-to-digital converter (ADC) and/or a digital-to-analog converter (DAC) located on an external digitizer/instrument card, thereby allowing for efficient and high-speed data transfer between the FPGA 250 and the digitizer/instrument card. The SerDes 265 can communicate with external hardware through the board-level physical layer interface 280, enabling high-speed data transfer over a small number of signal lanes. In the depicted example, 16 SerDes lanes are connected to respective pins of the P1 connector 284, and 8 SerDes lanes are connected to respective pins of the P2 connector 286. In other examples, the distribution of SerDes lanes among different connectors can be varied.

The SBC 200 is configured to support Ethernet on the control plane. Specifically, the PCS unit 254 of the FPGA 250 and the MAC 234 of the processor 230 can work together to support high-speed Ethernet communication. The PCS unit 254 is responsible for the physical layer signaling and the encoding or decoding of data. It can communicate with the MAC 234, which frames Ethernet packets and manages access to the physical medium. In one specific example, 12 lanes of the SerDes 265 can be used for Ethernet communication. In other examples, a different number of SerDes lanes can be used for Ethernet communication.

The SBC 200 is also configured to support SpaceVPX in the control plane. The control plane of SpaceVPX, typically used for configuration and operational control, can utilize SpaceWire as its medium-speed data and control plane interface. The FPGA 250 can be used to manage these SpaceWire links, providing flexibility and programmability to the control plane. For example, the FPGA 250 can have one or more SpaceWire endpoints 256 (e.g., serving as source or destinations of a SpaceWire packet stream) connected to the SpaceWire router 248 of the processor 230. In the depicted example, three SpaceWire lanes can connect the SpaceWire router 248 to up to three SpaceWire endpoints 256. The SpaceWire router 248 can also be directly connected to the P2 connector 286, e.g., via four lanes connected to four pins in the P2 connector 286.

### Flash Memory

The flash controller 268 of the FPGA 250 can be configured to handle block reads, writes, erase operations, etc., and generally hides the complexity of accessing the flash memory 262. In some examples, the flash memory 262 can store configuration data for hardware (e.g., sensors, SRAM-based FPGAs, etc.) hosted on other boards within the system. In one specific example, the flash memory 262 can be a 1 gigabyte NAND flash memory that is radiation tolerant. In other examples, the flash memory 262 can have a different size. In some examples, the flash controller 268 can be implemented in VHDL. The flash controller 268 can enhance the capabilities of the processor 230 by facilitating efficient read and write operations on individual bytes or multiple bytes within the flash memory 262. This stands in contrast to conventional methods that necessitate intricate sequences of commands to manage the erasure, writing, and retrieval of entire 4-Kbyte memory blocks. Thus, the processor 230 can seamlessly interface with the flash memory 262 as if it were an SRAM, while the FPGA 250 efficiently handles the hardware-intensive tasks associated with complete block reads and writes. When the processor 230 initiates a single-byte write, the FPGA 250 intervenes by reading the entire 4 Kbyte block into its memory, modifying the specified byte, erasing the accessed flash block, and subsequently rewriting the entire block to the flash. The entire operation can be hidden from the processor 230. In this manner, the FPGA 250 can act as a hardware co-processor for flash interactions.

### DDR2 Memory

The DDR controller 266 of the FPGA 250 is configured to manage the DDR2 memory 260. In one specific example, the DDR2 memory 260 can have a size of 256 megabyte. In other examples, the DDR2 memory 260 can have a different size. The DDR controller 266 allows for efficient communication with DDR2 memory 260. The FPGA 250 can leverage the high-speed, high-bandwidth characteristics of the DDR2 memory 260 to enhance both its own reconfigurability and the efficiency of the processor 230.

In one example, the FPGA 250 can use the DDR2 memory 260 as a buffer for data coming from the SerDes 265. For instance, sensor data generated by an external sensor board can be serialized before sending it to the FPGA 250. The FPGA 250 can then store the serialized data in the DDR2 memory 260. This allows the FPGA 250 to manage the incoming data flow effectively, ensuring that no data is lost if the rate of data arrival temporarily exceeds the FPGA's processing capacity. The FPGA can then retrieve the buffered sensor data from the DDR2 memory 260 as needed, providing flexibility in terms of when and how the data is processed.

As another example, the DDR2 memory 260, when used with an FPGA 250, can significantly enhance the efficiency of data processing tasks like FFT. Temporary data generated during these tasks, if stored on the FPGA 250, can consume valuable resources. By storing this data in DDR2 memory 260, the FPGA 250 can free up its resources for other tasks. The high-speed nature of DDR2 memory 260 ensures that data read/write operations do not hinder the processing pipeline. This allows the FPGA 250 to handle larger data sets or more complex algorithms, thereby improving operational efficiency. Additionally, the reconfigurability of the FPGA 250 also allows it to adjust its use of DDR2 memory 260 based on the specific requirements of each task, providing further efficiency.

As yet another example, the DDR2 memory 260 can also be used as a buffer for communication data to be sent by the processor 230. For example, the processor 230 can write data to the DDR2 memory 260 at its own pace, and the FPGA 250 can read this data when it is ready to send it. By decoupling the data production rate of the processor 230 from the data transmission rate of the FPGA 250, overall data transmission efficiency of the SBC 200 can be improved.

The reconfigurability of the FPGA 250 allows for flexibility in design and function, which can be particularly beneficial in applications where system requirements may change over time. In any of the above examples, the use of DDR2 memory 260 as a buffer also provides flexibility in terms of data management, allowing the FPGA 250 to handle varying data rates and sizes effectively.

Furthermore, the DDR2 memory 260 can be used to enhance reconfigurability of the FPGA 250. For example, the FPGA 250 can be reprogrammed to perform a wide range of functions based on parameters stored in the DDR2 memory 260. In other words, by updating these parameters, the functionality of the FPGA 250 can be altered. For example, if a soft-core processor is implemented in or programmed into the FPGA 250, the DDR2 memory 260 can store the instructions and data for this processor, effectively controlling its operation. Similarly, if the FPGA 250 is set up to perform filtering tasks, the DDR2 memory 260 can store the coefficients for these filters. Thus, the DDR2 memory 260 can act as a dynamic parameter storage, allowing the FPGA 250 to adapt its function based on the stored parameters. This setup significantly enhances the versatility and adaptability of the FPGA 250, making it suitable for a wide range of applications. In essence, the DDR2 memory 260 serves as a flexible interface for programming the FPGA 250, enabling it to perform different functions based on the updated parameters.

### Example Distributed Processor Module

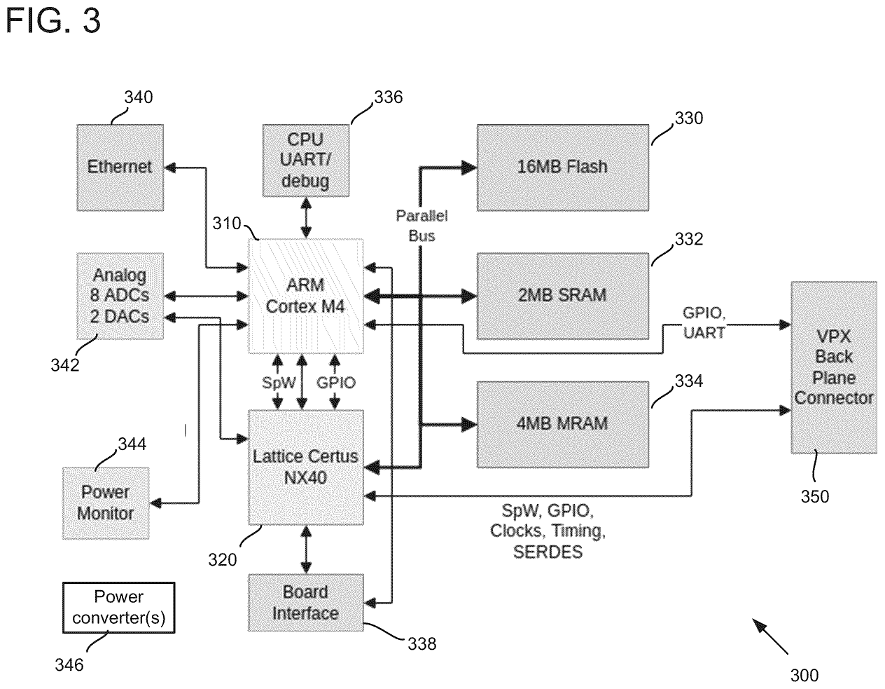

FIG. 3 is a block diagram depicting an example DPM 300 which can be an embodiment of the DPM 110 of FIG. 1.

The DPM 300 can be a reusable reference design for low-power digital electronics at various sensor boards, serving as an enabling technology for a distributed computing architecture. The DPM 300 can be configured as a stand-alone unit that is mechanically separated and tethered to a smaller, less resource-intensive hub (e.g., the SBC 200 of FIG. 2), providing flexibility and adaptability when integrating to mechanical and electrical requirements of a particular host. This distributed computing architecture enables “smart” sensors, i.e., self-contained sensors with data processing at the sensor head or sensor board, which are easier to test, integrate, and re-use. In some examples, the DPM 300 is configured to have a power consumption of less than 2.5 W/unit (e.g., about 2.37 W/unit).

The DPM 300 can include a radiation hardened processor 310 and a radiation hardened coprocessor or FPGA 320. For example, both the processor 310 and FPGA 320 can be radiation hardened to tolerate an ionizing dose of at least 100 kRad. In the example depicted in FIG. 3, the processor 310 is a Vorago VA41630 radiation-hardened Arm Cortex-M4 microcontroller, and the FPGA 320 is a Lattice Certus-NX LFD2NX-40 radiation-tolerant FPGA. In other examples, different processors and/or FPGAs can be used. For example, the processor 310 can be a radiation hardened SAMRH707 microcontroller, and the FPGA 320 can be a CertusPro-NX LFCPNX-100 FPGA.

In some examples, the processor 310 can include 256 KB of internal Ferroelectric Random Access Memory (FRAM), 320 KB of internal SRAM, integrated EDAC, a single-precision floating-point unit (FPU), a direct memory access (DMA) controller, an external bus interface (EBI), a SpaceWire endpoint, a 10/100 Ethernet MAC, and a variety of serial interfaces. and a variety of serial interfaces. In some examples, the FPGA 320 can include at least 40 k equivalent logic cells, a 1.25 Gbps SerDes and an 18-channel 1-MSPS ADC. Different processors and/or FPGAs can have different features. For instance, the FPGA 320 can alternatively have 100 k equivalent logic cells, eight 10.3 Gbps SerDes and an 18-channel 1-MSPS ADC.

Besides the processor 310 and FPGA 320, various other components of the DPM 300 are also radiation hardened (e.g., to tolerate an ionizing dose of at least 100 kRad). These radiation hardened components can include an eight-channel ADC and a two-channel DAC 342 respectively connected to the processor 310 and the FPGA 320, one or more memory chips (e.g., a 16 MB flash memory 330 including an 8 MB parallel flash and an 8 MB serial flash, a 2 MB SRAM 332, and a 4 MB MRAM 334) in communication with the processor 310 and the FPGA 320, one or more power conversion circuits 346 configured to get power from satellite host bus or battery such as linear power converters, switch mode power converters, etc. In some examples, the radiation hardened components can further include an Ethernet physical layer chip 340 (e.g., VSC8541RT) connected to the processor 310, a CPU UART debug unit 336 in serial communication with the processor 310 (e.g., for debugging and diagnostic purposes), and one or more board interface connectors 338 which can be used for connecting with front-end electronics that are located on the same board as the DPM 300. In some examples, the DPM 300 can include a radiation hardened power monitor 344 configured to monitor power consumption of the DPM 300. In some examples, the power monitor 344 can be located on a separate board such as the LVPM board 130.

The EBI can be used for communication between the processor 310 and FPGA 320. In some examples, the processor 310 and FPGA 320 can communicate with each other through SpaceWire, general purpose input/output (GPIO) lines, and/or other high-speed serial interfaces. The DPM 300 can communicate with other boards, including the payload processor, through a VPX backplane connector 350 (e.g., compatible to the VPX backplane 180 of FIG. 1), thereby enabling efficient data exchange and synchronization across a distributed computing system. In some examples, the VPX backplane connector 350 can have a 3U-sized form factor.

In some examples, the processor 310 can be connected to the VPX backplane connector 350 using a variety of serial protocols. For example, the processor 310 can be connected to the VPX backplane connector 350 through a UART interface, and/or GPIO lines. In some examples, the processor 310 can also be directly connected to the VPX backplane connector 350 through a SpaceWire interface.

In some examples, the FPGA 320 can be connected to the VPX backplane connector 350 through several serial interfaces, such as a SerDes interface, a SpaceWire interface, GPIO lines, etc. Additionally, the FPGA 320 can also be connected to the VPX backplane connector 350 through clocks and timing lines, which synchronizes operations between different modules in the system.

As described above, the DPM 300 can be used in multiple boards of a distributed computing system. Each DPM 300 can be individually programmed for the specific purpose of the board on which it is located, allowing for a high degree of customization and flexibility. As a result, these boards are compatible and can communicate with each other efficiently. For instance, a sensor board (e.g., the WPS sensor board 160, the ECP telescope 170, etc.) can have an on-board DPM 300 and a specific sensor (e.g., the WPS sensor 165, the ECP sensor 175, etc.) configured to measure a specific parameter of the space flight environment. The processor 310 of the DPM 300 can be configured to generate processed sensor data by processing the parameter measured by the sensor. The FPGA 320 can be configured to send this processed sensor data to the payload processor (e.g., the SBC 120 or 200) through the VPX backplane connector 350 (e.g., via the SpaceWire interface).

### Example Wide Field-of-View Plasma Spectrometer

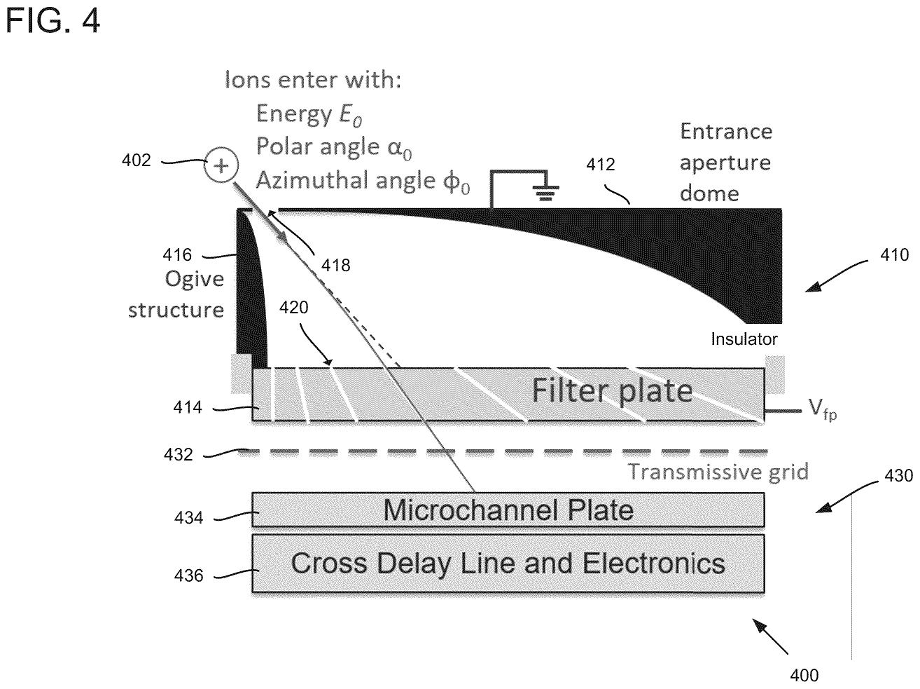

FIG. 4 depicts a WPS sensor 400 which can be used in a sensor board (e.g., WPS sensor board 160) having an on-board DPM described herein.

The WPS sensor 400 is configured measure ion and electron energies and incident angles over a nearly 2π FOV. In some examples, the WPS sensor 400 can acquire a complete plasma measurement in a single voltage sweep and measures a broad FOV without relying on spacecraft spin or deflection plates, thus making it an attractive option for an electrostatic analyzer design for a three-axis stabilized spacecraft.

The WPS sensor 400 requires the processor of the on-board DPM to perform on-the-fly data processing. The main task of this application-specific functionality involves generating a histogram from the FPGA data product. Specifically, a double buffer data passing scheme can be used to transmit data from the FPGA's internal RAM banks, across the EBI, and into the processor. An instrument flight software running on the processor can accumulate the data in an SRAM connected to the EBI and process it to generate a histogram. The processor of the on-board DPM can then transmit the histogram over SpaceWire along with a portion of the raw data and state of health information to the payload processor. In some examples, the payload processor can command the on-board DPM. For example, the commanding can provide the means to set the operational mode of the WPS sensor 400, the desired data format (with or without debug information), the volume of raw data that should accompany each histogram, and other configuration parameters.

In some examples, the WPS sensor 400 can include two subsystems: a sensor head 410 and a detector 430. The sensor head 410 can include an upper dome 412, an energy-angle (EA) charged particle filter plate 414, and an ogive “bullet” structure 416 at the center of the EA filter plate 414. An ion 402 enters a pinhole aperture 418 in the upper dome 412 with a specific incident energy (E₀) and angles (α₀, ϕ₀). The ion 402 then travels towards the EA filter plate 414, which is held at a certain voltage (V_{fp}). The EA filter plate 414 includes a series of slots 420 whose bias angle (b) varies as a function of radius r. The ion 402 traverses the slot 420 in the filter plate 414 as long as its angle (β) matches the bias angle (b) of the slot 420.

The detector 430 includes an electroformed nickel mesh grid, also referred to as transmissive grid 432, a microchannel plate (MCP) stack 434 which detects individual particles, a position sensitive crossed delay line (XDL) anode 436 and associated front-end electronics. After passing through the filter plate 414, the ion 402 passes through the transmissive grid 432 and impacts the MCP stack 434 and the imaging XDL anode 436. The radial location maps to the incident polar angle of the ion (α₀); the azimuthal location maps to the incident azimuthal angle of the ion (ϕ₀); and the EA filter plate voltage (V_{fp}) maps to the incident energy of the ion (E₀).

The WPS sensor 400 requires static high voltage to provide operational bias to MCP stack 434. Such bias voltage can be provided by a high voltage power supply, such as the second HVPS board 150 described above.

The operation of the WPS sensor 400 also involves sweeping the EA filter plate voltage (V_{fp}) over a range of voltages to obtain the full energy distribution of incident ions 402. This process allows the WPS sensor 400 to map the parameters (V_{fp}, r, β) to the properties (E₀, α₀, ϕ₀) of the incident ion 402. A stepping high voltage supply (e.g., the first HVPS board 140) can be used to sweep the EA filter plate in a predefined voltage range. In some examples, voltage stepping can be controlled by the processor of the on-board DPM.

In some examples, the WPS sensor 400 can be reduced to a WPS wedge, which measures ions with incident energies spanning 0.10-35 keV with targeted energy resolution ΔE/E≤0.15 and an FOV of 89°×60°.

The location of the ions incident on the detector plane can be observed using the MCP stack 434 followed by the XDL anode 436. An incident ion 402 strikes the front of the MCP stack 434 and generates a secondary electron avalanche, resulting in a gain of ˜10⁷, which exits the MCP stack 434, depositing the resulting charge on the XDL anode 436. The XDL anode 436 can be formed by two orthogonal serpentine conductors and the position of the charge pulse can then be determined by the difference in arrival time of the pulse at the ends of resistive-capacitance delay lines. For example, the electron generation in the MCP stack 434 can create a start pulse. The charge from the electron cloud then travels along the XDL anode 436 resulting in four stop pulses at X₁, X₂, Y₁, and Y₂. Analog front-end electronics can be configured to process the pulses and determine timing.

The analog front-end electronics can include high gain-bandwidth product operational amplifiers and fast comparators configured in a constant fraction discriminator (CFD) topology at the end of each delay line. This circuit can amplify the pulses from the XDL anode 436 and translate the analog pulse to a digital signal to drive the start and stop inputs on one or more time-to-digital converter (TDC) integrated circuits. Utilizing CFD topology can negate the effects of conventional threshold triggering which inherently may introduce errors in timing measurements between analog input pulses of varying amplitudes. The CFD circuit behaves as an amplitude-invariant mechanism to drive the TDCs. The resolution of the assembly may be determined by the event timing error which is generally dominated by the CFD performance. In some examples, the FPGA of the on-board DPM can interface with the TDC, calculate the (x, y) coordinates and flag invalid readings.

The digital electronics then receive the start (MCP) and stop (X₁, X₂, Y₁, Y₂) pulses from which four travel times can be determined. Note that the travel times are the time scale required for the charge pulse striking the XDL to travel to the ends of the XDL anode 436. These travel times can then be used to calculate, e.g., by the FPGA of the on-board DPM, the (x, y) position of the location the ion 402 landed on the MCP stack 434. These data can be sent to the processor of the on-board DPM where the instrument flight software bins the data at each voltage step of the filter plate 414, resulting in an energy and angle histogram per voltage step.

In some examples, the payload processor can control operation (e.g., activation, deactivation, etc.) of the WPS sensor 400 by sending command signals through the on-board DPM. The payload processor can also obtain sensor status and/or measurement data from the WPS sensor 400 through the on-board DPM. For example, the WPS sensor 400 can send the generated histograms to the payload processor for post-processing and/or data storage.

### Example Energetic Charged Particle Telescope

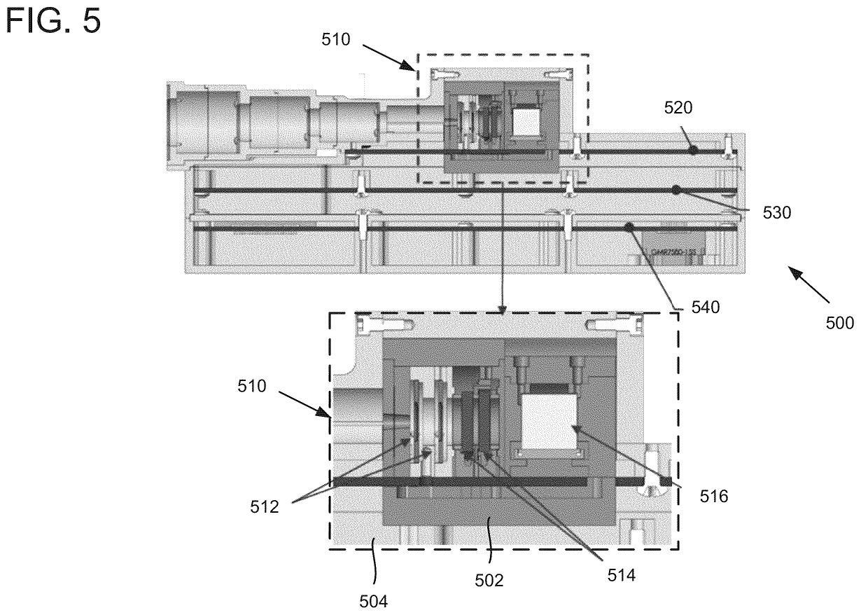

FIG. 5 depicts an example ECP telescope 500 including an ECP sensor 510. An enlarged view of the ECP sensor 510 is shown in a dashed box at the bottom of FIG. 5. The ECP telescope 500 can be an embodiment of the ECP telescope 170 of FIG. 1.

The ECP telescope 500 is configured to measure protons and electrons across a wide energy spectrum, e.g., ranging from 100 keV to 1000 MeV for protons, and 100 keV to 20 MeV for electrons. The ECP sensor 510 can include a stack of five detectors: two thin Si detectors 512 (e.g., about 80 μm thick), two thick Si detectors 514 (e.g., about 1500 μm thick), and a GAGG(Ce) scintillator 516 (e.g., about 1 cm thick) doped with Ce3+ and paired with a Hamamatsu S3590-08 PhotoDiode (PD). The ECP sensor 510 requires static high voltage to provide operational bias to the solid-state detectors. Such bias voltage can be provided by a high voltage power supply, such as the second HVPS board 150 described above. The ECP sensor 510 can be shielded with tungsten 502 and aluminum 504. To reduce background noise and enhance the signal-to-noise ratio, an aluminum collimator fitted with tungsten discs can be positioned at the front of the ECP telescope 500.

Each channel of the ECP telescope 500 can be equipped with dedicated read-out electronics, which are integrated into the telescope's body. Each electronics module can include three electronic boards configured to fit the allocated footprint while minimizing noise and heat cross-talks. A sensor interface module 520 is configured to provide a low-noise interface between the electronics and detectors, supply detector biasing, and monitor leakage current. A front-end electronics module 530 incorporates junction-gate field-effect transistors (JFETs) and charge-sensitive preamplifiers to amplify detector signals. Once the amplified signals are shaped and filtered, they can be sampled by an ADC at a rate of 80 MHz. The digitized signal can then be passed to an on-board DPM 540 for data processing.

For example, the FPGA of the on-board DPM 540 can interface with the ADC, convert the digitized signal to deposited energy and multiple the same by a calibration factor. The processor of the on-board DPM 540 can be configured to execute an energy reconstruction algorithm and perform command and data handling tasks.

In some examples, the payload processor can control operation (e.g., activation, deactivation, etc.) of the ECP telescope 500 by sending command signals through the on-board DPM. The payload processor can also obtain sensor data from the ECP telescope 500 through the on-board DPM. For example, the ECP telescope 500 can send the converted energy data to the payload processor for post-processing and/or data storage.

### Example Methods for Distributed Data Processing in Space Flight Environments

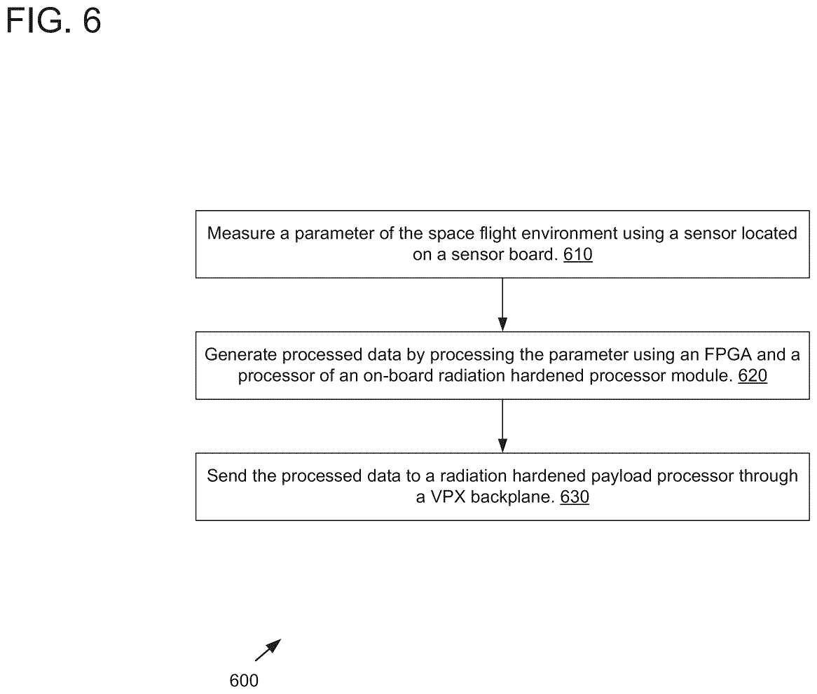

FIG. 6 is a flowchart depicting an example overall method 600 for distributed data processing in space flight environments, e.g., using the computing system 100.

At step 610, the method can measure a parameter of the space flight environment using a sensor located on a sensor board. The sensor board includes a radiation hardened processor module.

At step 620, the method can generate processed data by processing the parameter using an FPGA and a processor of the radiation hardened processor module. In some examples, the processed data can include a histogram of the measured parameter.

Then, at step 630, the method can send the processed data to a radiation hardened payload processor through a VPX backplane. Both the sensor board and the radiation hardened payload processor are connected to the VPX backplane.

In some examples, such data communication can be implemented via a SpaceWire interface on the VPX backplane.

In some examples, a specific voltage can be applied to the sensor board using a power supply board which includes the same radiation hardened processor module. In some examples, power consumption of the sensor board can be monitored using a power monitoring board including the same radiation hardened processor module. Both the power supply board and the power monitoring board can be connected the VPX backplane.

### Example Advantages

Compared to the conventional “backplane in a box,” or centralized computing systems, the disclosed technologies offer a more flexible and adaptable distributed computing system, enabled by the usage of DPMs.

The DPMs disclosed herein allow for the creation of “smart” sensors which are capable of processing data directly at the sensor head. The usage of DPMs supports edge computing by offloading some of the computing burden from the payload processor, thereby enhancing overall system performance.

The usage of DPMs can streamline the testing, integration, and reuse of the sensors for various space flight applications. Specifically, different sensor boards can share the same DPM hardware and a significant portion of the related firmware. This shared structure can accelerate the design and testing phases, reducing the time and resources required for hardware and firmware development. It also enhances the reusability of the modules, as the same DPM can be used in different contexts with different front-end electronics. Moreover, the usage of DPMs improves system modularity, making it easier to add or remove sub-instruments from the system as needed.

Further, the technologies disclosed herein improves the compatibility for communication among different boards of the space flight computing system when the boards use the same DPMs. This facilitates their ability to ‘talk’ to each other, thereby promoting system integration and reducing the need for complex interface designs.

### General Considerations

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved. The technologies from any example can be combined with the technologies described in any one or more of the other examples. In view of the many possible examples to which the principles of the disclosed technology may be applied, it should be recognized that the illustrated examples are only preferred examples and should not be taken as limiting the scope of the disclosed technology.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art. Any theories of operation are to facilitate explanation, but the disclosed systems, methods, and apparatus are not limited to such theories of operation.

As used in this application and in the claims, the singular forms “a,” “an,” and “the” include the plural forms unless the context clearly dictates otherwise. Additionally, the term “includes” means “comprises.” Further, the terms “coupled” and “connected” generally mean electrically, electromagnetically, and/or physically (e.g., mechanically or chemically) coupled or linked and does not exclude the presence of intermediate elements between the coupled or associated items absent specific contrary language.

As used herein, “and/or” means “and” or “or,” as well as “and” and “or.” Example Alternatives

As will be appreciated, the embodiments described above are provided for explanatory purposes only and the present disclosure is not limited to the description above. The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A distributed computing system for a space flight environment, the distributed computing system comprising:
a radiation hardened single board computer (SBC); and
a peripheral board comprising a radiation hardened processor module,
wherein the radiation hardened SBC comprises a first radiation hardened processor and a first radiation hardened field programmable gate array (FPGA),
wherein the radiation hardened processor module comprises a second radiation hardened processor and a second radiation hardened FPGA,
wherein the radiation hardened processor module is connected to the radiation hardened SBC through a VPX backplane.

2. The distributed computing system of claim 1, wherein the radiation hardened processor module further comprises one or more radiation hardened analog-to-digital converters in communication with the second radiation hardened processor.

3. The distributed computing system of claim 1, wherein the radiation hardened processor module further comprises one or more radiation hardened digital-to-analog converters in communication with the second radiation hardened FPGA.

4. The distributed computing system of claim 1, wherein the radiation hardened processor module further comprises one or more radiation hardened memory chips in communication with the second radiation hardened FPGA.

5. The distributed computing system of claim 1, wherein the radiation hardened processor module further comprises one or more radiation hardened power conversion circuits.

6. The distributed computing system of claim 1, wherein the radiation hardened processor module further comprises one or more radiation hardened transceiver units.

7. The distributed computing system of claim 1, wherein the second radiation hardened processor is connected to the VPX backplane through a universal asynchronous receiver/transmitter (UART) interface.

8. The distributed computing system of claim 1, wherein both the second radiation hardened processor and the second radiation hardened FPGA are connected to the VPX backplane through a SpaceWire interface.

9. The distributed computing system of claim 1, wherein the second radiation hardened FPGA is connected to the VPX backplane through a serializer-deserializer (SerDes) interface.

10. The distributed computing system of claim 1, wherein the peripheral board further comprises a sensor configured to measure multiple travel times of an ion incident on a detector, wherein the second radiation hardened FPGA is configured to calculate two-dimensional coordinates of the ion incident on the detector, wherein the second radiation hardened processor is configured to generate a histogram based on the two-dimensional coordinates calculated by the second radiation hardened FPGA.

11. A distributed computing system for a space-flight environment, the distributed computing system comprising:
a first sensor board comprising a first sensor and a radiation hardened processor module; and
a second sensor board comprising a second sensor different from the first sensor and the radiation hardened processor module,
wherein the radiation hardened processor module comprises a radiation hardened processor and a radiation hardened field programmable gate array (FPGA),
wherein the radiation hardened processor modules of both the first sensor board and the second sensor board are connected to a radiation hardened payload processor through a VPX backplane.

12. The distributed computing system of claim 11, wherein the VPX backplane has a 3U-sized form factor.

13. The distributed computing system of claim 11, further comprising a high voltage power supply board comprising a voltage generator and the radiation hardened processor module, wherein the radiation hardened processor module of the high voltage power supply board is configured to control the voltage generator to generate a specific voltage that is applied to the first sensor of the first sensor board or the second sensor of the second sensor board.

14. The distributed computing system of claim 11, wherein the radiation hardened processor module is configured to support both Ethernet and SpaceWire communication with the radiation hardened payload processor.

15. The distributed computing system of claim 11, wherein the radiation hardened processor module is configured to tolerate an ionizing dose of at least 100 kRad.

16. The distributed computing system of claim 11, wherein the radiation hardened processor module is configured to have a power consumption of less than 2.5 W/unit.

17. A method for distributed data processing in a space flight environment, the method comprising:
measuring a parameter of the space flight environment using a sensor located on a sensor board, wherein the sensor board comprises a radiation hardened processor module;
generating processed data by processing the parameter using a field programmable gate array and a processor of the radiation hardened processor module; and
sending the processed data to a radiation hardened payload processor through a VPX backplane,
wherein both the sensor board and the radiation hardened payload processor are connected to the VPX backplane.

18. The method of claim 17, wherein the processed data is sent from the sensor board to the radiation hardened payload processor via a SpaceWire interface on the VPX backplane.

19. The method of claim 17, further comprising applying a specific voltage to the sensor board using a power supply board comprising the radiation hardened processor module.

20. The method of claim 17, further comprising monitoring power consumption of the sensor board using a power monitoring board comprising the radiation hardened processor module.
